(19) United States
(12) Patent Application Publication
(10) Pub. No.: US 2019/0116780 A1
(43) Pub. Date: Apr. 25, 2019

(54) Hunting-Attractant Dispenser

(71) Applicant: Jerry W. Agee, Paragould, AR (US)

(72) Inventor: Jerry W. Agee, Paragould, AR (US)

(21) Appl. No.: 15/902,267

(22) Filed: Feb. 22, 2018

Related U.S. Application Data
(60) Provisional application No. 62/574,859, filed on Oct. 20, 2017.

(51) Int. Cl. A01M 31/00

(52) U.S. Cl. CPC A01M 31/008; A01N 63/00

(57) ABSTRACT

The hunting-attractant dispenser is an apparatus that allows only the attractant solution, which is immediately consumed by an animal, to be accessed. The apparatus includes a supply tank, an attractant slot, a wheel, and an axle rod. The supply tank contains attractant solution. The attractant slot allows an animal to access the attractant solution within the supply tank. The wheel delivers attractant solution from within the supply tank to the tongue and the mouth of an animal. Moreover, the wheel allows an animal to engage the apparatus and drink the attractant solution. The axle rod allows the wheel to rotate. Moreover, the wheel allows the attractant solution to continuously cover the wheel as the wheel rotates. The apparatus further includes a first elongated mounting brace and a second elongated mounting brace, both of which stabilizes the apparatus onto the ground.

The current application claims a priority to the U.S. Provisional Patent application Ser. No. 62/574,859 filed on Oct. 20, 2017.

### FIELD OF THE INVENTION

The present invention generally relates to dispensers. More specifically, hunting-attractant dispenser that limits the waste of attractant solution within the present invention while effectively luring an animal to a desired position.

### BACKGROUND OF THE INVENTION

In order to attract animals to a desired position, hunters pour attractant solution on the ground or on a tree stump. Though the area on the ground or the tree stump does attract animals, this attraction is temporary. Hunters have to reapply the attractant solution if one or more animals have consumed the attractant solution. Rainwater washes away the attractant solution very quickly also, forcing the hunter to reapply the attractant solution as well. Each time the hunter reapplies attractant solution, whether it is on the ground itself or a tree stump, the hunter risks the deterring animals from the desired position.

It is therefore the objective of the present invention to provide a reserve of attractant solution that is not wasted by animals or other environmental factors such as rainwater. The present invention allows a hunter to use more attractant solution than typical methods or comparable apparatuses. The present invention limits wasted attractant solution as the attractant solution is dispensed only when engaged by an animal. The present invention allows the smell of the attractant solution to also be continuously emitted.

### BRIEF DESCRIPTION OF THE DRAWINGS

FIG. 1 is a front perspective view of the present invention.

FIG. 2 is a front side view of the present invention.

FIG. 3 is a left side view of the present invention.

FIG. 4 is a top side view of the present invention.

FIG. 5 is a cross-section view of FIG. 4 along line 5-5 of the present invention.

FIG. 6 is a cross-section view of FIG. 4 along line 6-6 of the present invention.

FIG. 7 is a front exploded view of the present invention.

FIG. 8 is a rear exploded view of the present invention.

FIG. 9 is a top side view of the first elongated mounting brace of the present invention with a first camouflage layer.

FIG. 10 is a cross-section view of FIG. 9 along line 10-10 of the present invention.

FIG. 11 is a top side view of the second elongated mounting brace of the present invention with a second camouflage layer.

FIG. 12 is a cross-section view of FIG. 11 along line 12-12 of the present invention.

FIG. 13 is a top side view of the supply tank of the present invention with a camouflage layer.

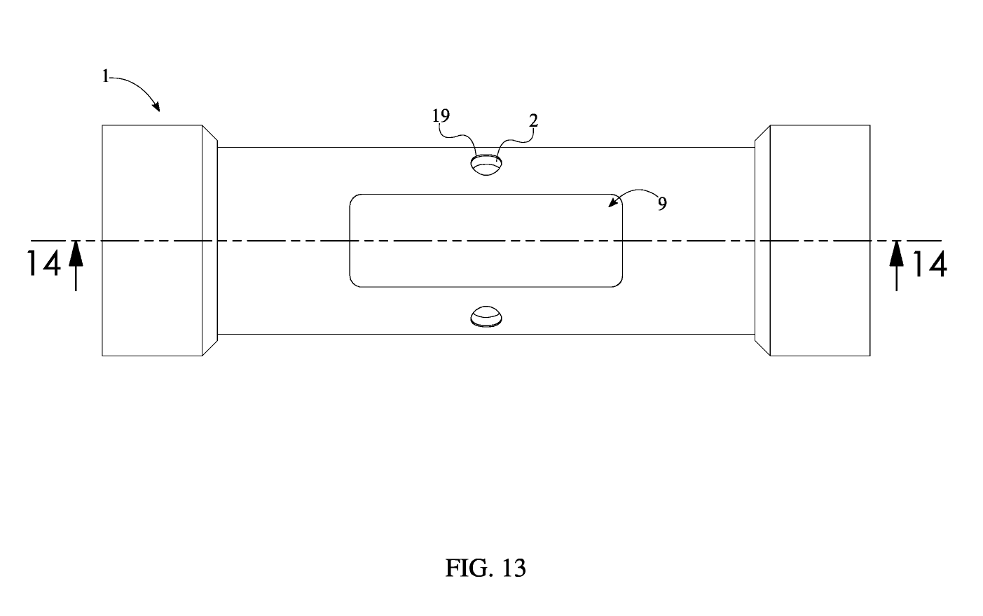

FIG. 14 is a cross-section view of FIG. 13 along line 14-14 of the present invention.

FIG. 15 is a top side view of the present invention with at least one fill hole.

### DETAIL DESCRIPTIONS OF THE INVENTION

All illustrations of the drawings are for the purpose of describing selected versions of the present invention and are not intended to limit the scope of the present invention.

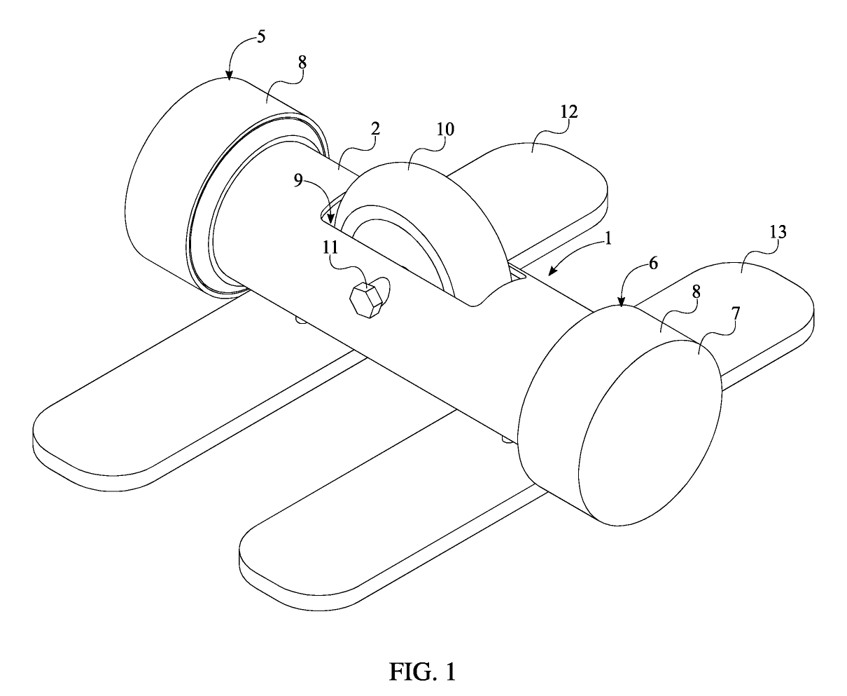

The present invention is a hunting-attractant dispenser that limits the amount of attractant solution that is wasted. The present invention is effectively stabilized and prevents any attractant solution from accidentally spilling. More specifically, attractant solution is only dispensed while being licked by an animal. The present invention comprises a supply tank 1, an attractant slot 9, a wheel 10, and an axle rod 11, as seen in FIG. 1. The supply tank 1 contains the attractant solution and upholds the axle rod 11. The attractant slot 9 allows the attractant solution within the supply tank 1 to exit the supply tank 1. The scent of the attractant solution escapes the supply tank 1 through the attractant slot 9 as well and enters the surrounding environment, thereby luring animals to the present invention. The wheel 10 delivers the attractant solution within the supply tank 1 to the tongue and mouth of the animal that is engaging the present invention. The wheel 10 may comprise a smooth curved surface. An alternate embodiment of the wheel 10 may also comprise a plurality of grooves along the curved surface of the wheel 10. The axle rod 11 mounts the wheel 10 to the supply tank 1 and allows the wheel 10 to rotate. In the preferred embodiment of the present invention, the axle rod 11 is a nut and a bolt such that the axle rod 11 is removable from the supply tank 1, and consequently, so is the wheel 10.

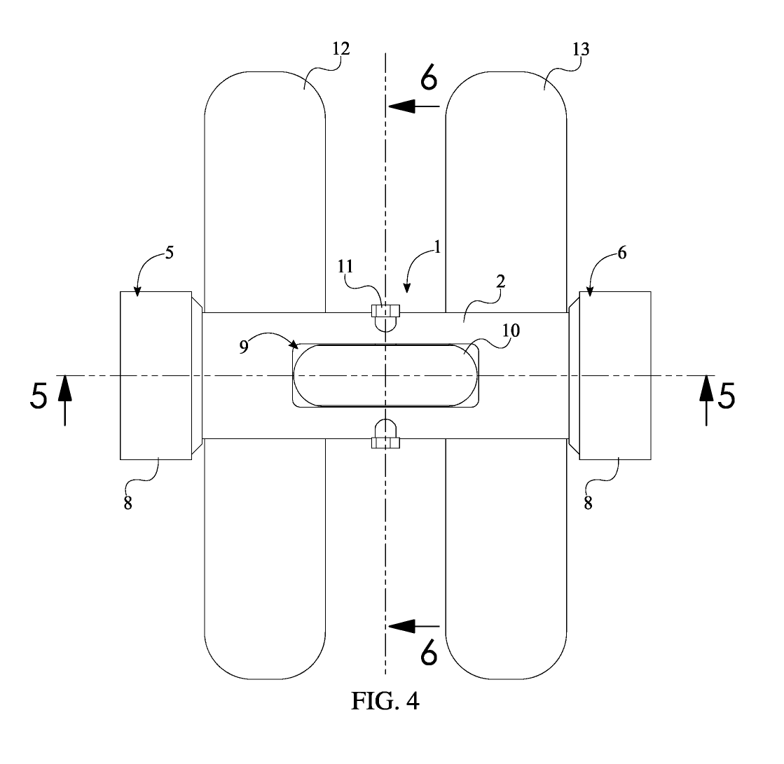

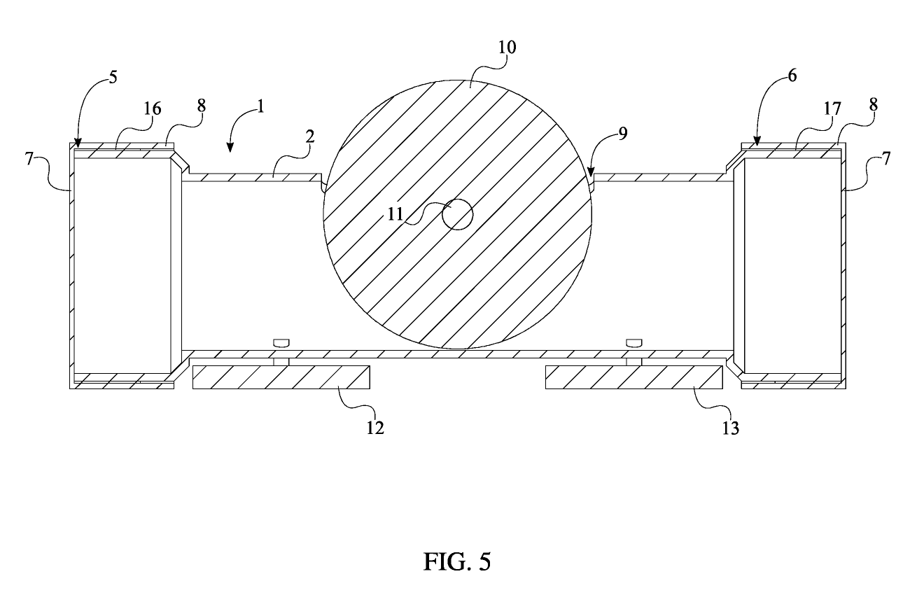

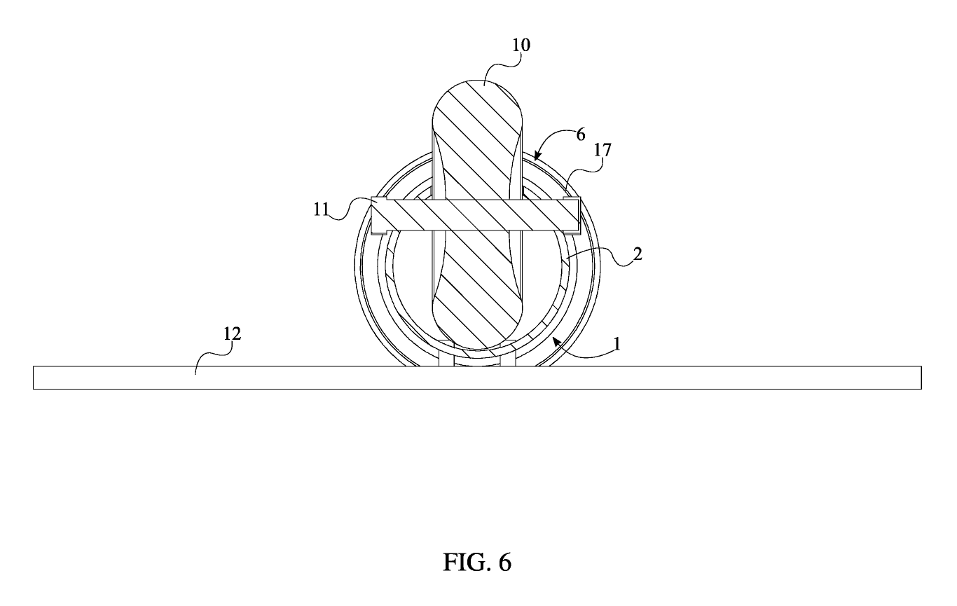

The overall configuration of the aforementioned components allows the present invention to dispense only the attractant solution that is going to be immediately consumed by an animal. In order for an animal to retrieve the attractant solution, the attractant slot 9 traverses into the supply tank 1, as seen in FIG. 5. As illustrated in FIG. 6, the axle rod 11 is mounted through the supply tank 1 and is positioned perpendicular and adjacent to the attractant slot 9. This arrangement orients the wheel 10 such that a portion of the wheel 10 is concealed within the supply tank 1 and a portion of the wheel 10 is exposed past the attractant slot 9 while the wheel 10 is rotating and stationary. The axle rod 11 is centrally aligned along the attractant slot 9, as shown in FIG. 4, so that wheel 10 does not come into contact with the supply tank 1 while the wheel 10 is rotating and stationary. More specifically, the wheel 10 is rotatably connected to the axle rod 11 and is positioned through the attractant slot 9. Therefore, the portion of the wheel 10 concealed within the supply tank 1 and is suspended in the attractant solution is able to continuously deliver attractant solution to the animal rotating the wheel with his or her tongue.

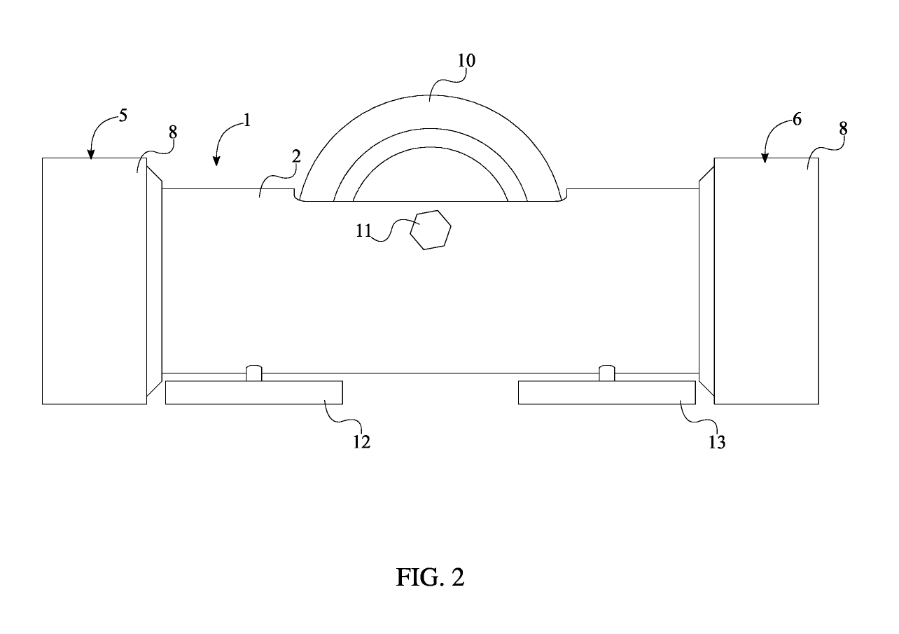

The present invention is stabilized on the ground as the present invention further comprises a first elongated mounting brace 12 and a second elongated mounting brace 13. The first elongated mounting brace 12 and the second elongated mounting brace 13 prevents the supply tank 1 from tilting. More specifically, the first elongated mounting brace 12 and the second elongated mounting brace 13 mounts the supply tank 1 while an animal is licking the wheel 10 and while the present invention is not in use by an animal. As seen in FIG. 1 and FIG. 5, the first elongated mounting brace 12 and the second elongated mounting brace 13 is connected adjacent to the supply tank 1, opposite the attractant slot 9. This arrangement orients the attractant slot 9 away from the ground. In order to structurally support the supply tank 1, the axle rod 11, the wheel 10, and the attractant solution, the first elongated mounting brace 12 is oriented parallel and offset to the second elongated mount brace 13, as seen in FIG. 2 and FIG. 4. More specifically, the first elongated mounting brace 12 and the second elongated mounting brace 13 are oriented perpendicular to the attractant slot 9.

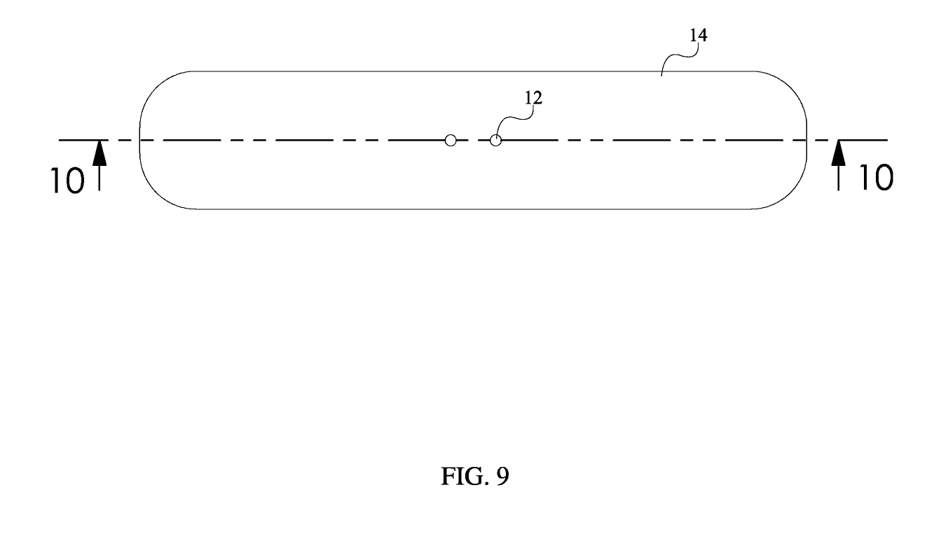

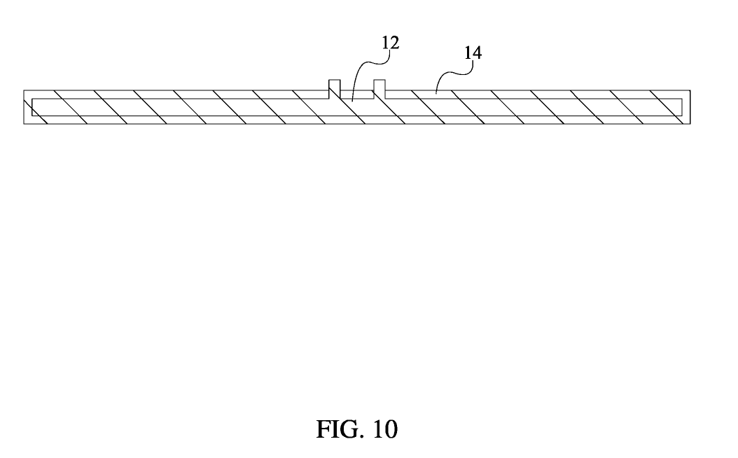

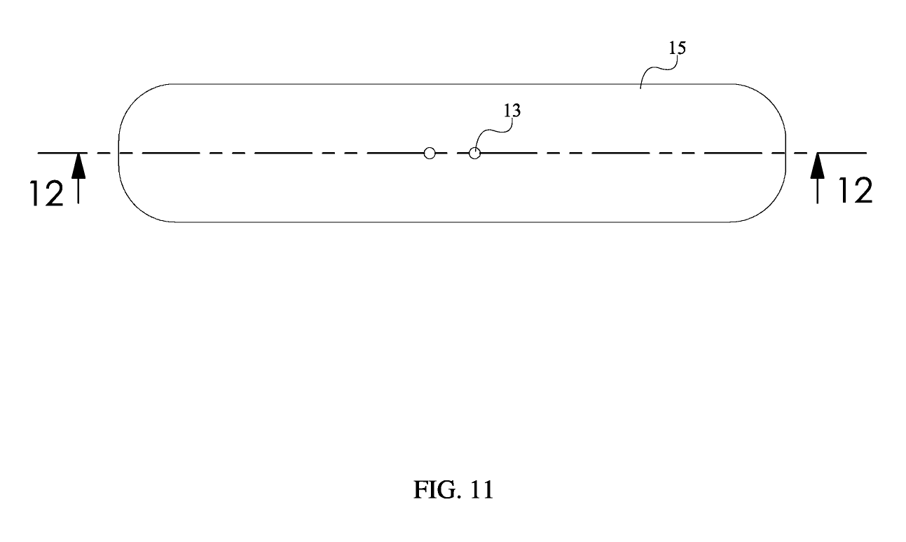

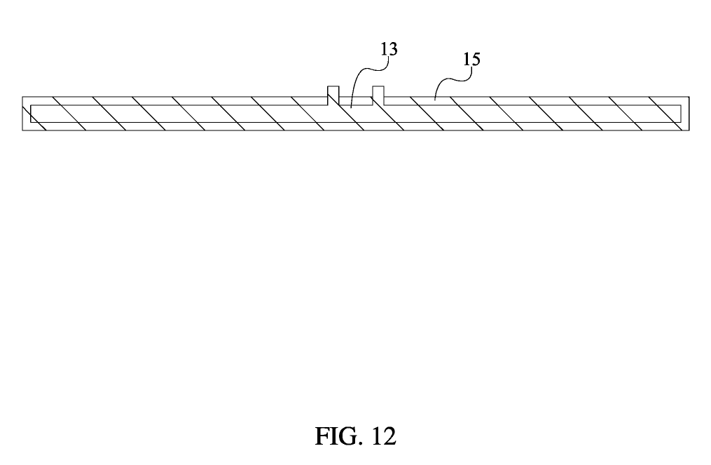

In an alternate embodiment of the present invention, the first elongated mounting brace 12 and the second elongated mounting brace 13 both blend in with the surrounding environment. This alternate embodiment further comprises a first camouflage layer 14 and a second camouflage layer 15 in order to blend the present invention with the surrounding environment and visually trick animals. The first camouflage layer 14 is externally adhered around the first elongated mounting brace 12, as illustrated in FIG. 9 and FIG. 10. Similarly, the second camouflage layer 15 is externally adhered around the second elongated mounting brace 13, illustrated in FIG. 11 and FIG. 12. This arrangement allows the present invention to blend in with the surrounding environment and allows the present invention to appear less threatening to an animal.

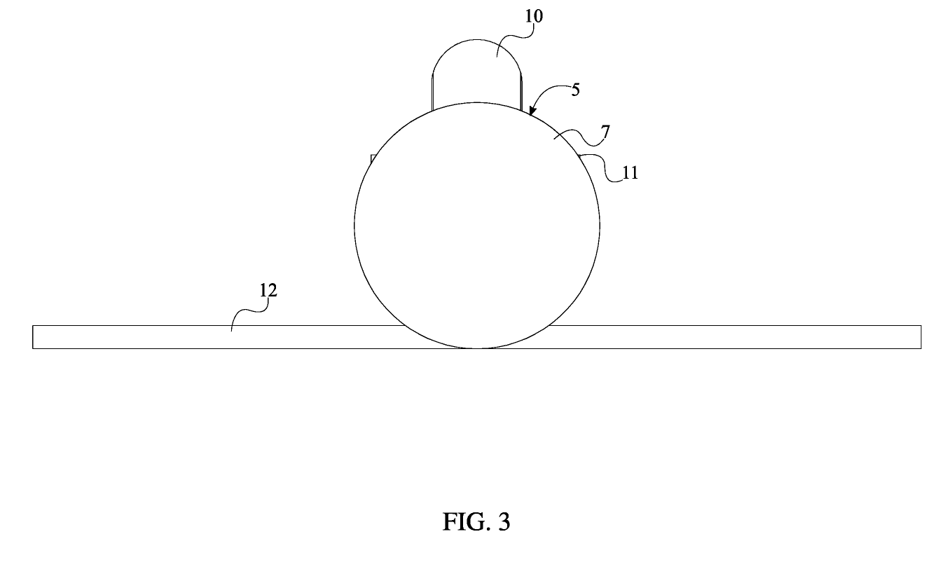

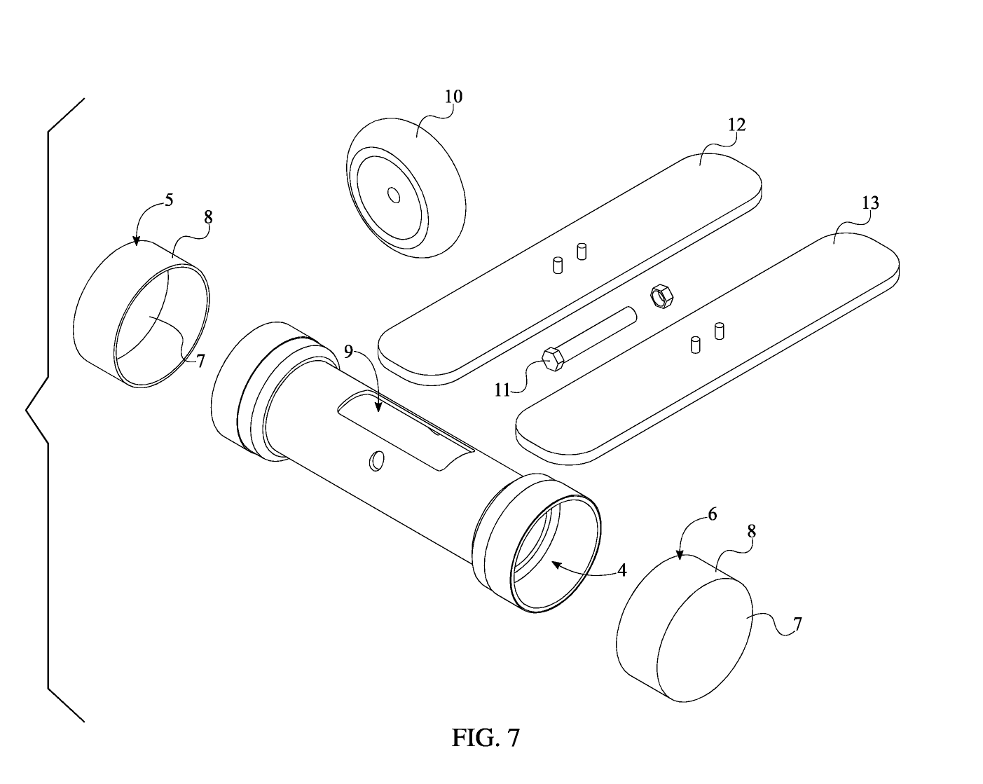

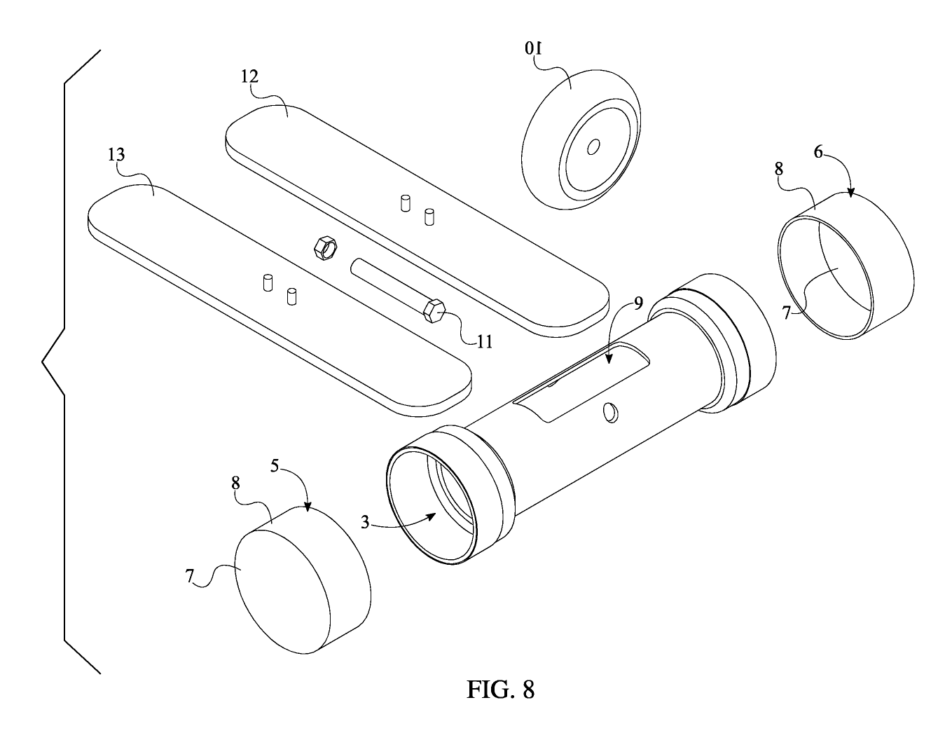

In order for the supply tank 1 to effectively contain attractant solution the supply tank 1 preferably comprises a tubular housing 2, a first cap 5, and a second cap 6. The tubular housing 2 allows the supply tank 1 to serve as a reserve of attractant solution. More specifically, the tubular housing 2 comprises a first open end 3 and a second open end 4, seen in FIG. 7 and FIG. 8. The first open end 3 and the second open end 4 allows the tubular housing 2 to be refilled without disconnecting the axle rod 11 and the wheel 10 from the supply tank 1. Both the first cap 5 and the second cap 6 contain the attractant solution within the tubular housing 2. Furthermore, the first cap 5, shown in FIG. 3, and the second cap 6 prevent the attractant solution from escaping through the first open end 3 and the second open end 4, respectively, as seen in FIG. 2 and FIG. 5. The attractant slot 9 is laterally positioned along the tubular housing 2 in between the first open end 3 and the second open end 4. This arrangement allows wheel 10 to freely rotate and axle rod 11 to be stabilized with the supply tank 1. The first cap 5 is hermetically connected to the first open end 3. Similarly, the second cap 6 is hermetically connected to the second open end 4. This arrangement effectively seals the tubular housing 2 along the first open end 3 and the second open end 4 while allowing the attractant solution to be accessed through the attractant slot 9.

As shown in FIG. 5, the preferred embodiment of the present invention further comprises a first sealant layer 16 and a second sealant layer 17 in order to prevent the attractant solution from leaking between both the first cap 5 and the second cap 6, respectively, and the supply tank 1. In order for the first cap 5 to connect to the supply tank 1, the first cap 5 comprises a base plate 7 and a rim 8. The base plate 7 covers the first open end 3, and the rim 8 connects the first cap 5 to the supply tank 1. The rim 8 is perimetrically connected to the base plate 7 and is oriented perpendicular to the base plate 7. This arrangement allows the rim 8 to surround the supply tank 1. More specifically, the base plate 7 is laterally positioned across the first open end 3. The rim 8 is laterally positioned around the tubular housing 2, adjacent to the first open end 3, allowing the base plate 7 to press directly against the supply tank 1 and cover the entirety of the first open end 3. The first sealant layer 16 is adhered in between the rim 8 and the tubular housing 2, thereby preventing any attractant solution from escaping from the first open end 3 and in between the rim 8 and the tubular housing 2.

Similarly, the second cap 6 comprises a base plate 7 and a rim 8, also seen in FIG. 5, FIG. 7, and FIG. 8. The base plate 7 covers the second open end 4, and the rim 8 connects the second cap 6 to the supply tank 1. The rim 8 is perimetrically connected to the base plate 7 and is oriented perpendicular to the base plate 7. This arrangement allows the rim 8 to surround the supply tank 1. More specifically, the base plate 7 is laterally positioned across the second open end 4. The rim 8 is laterally positioned around the tubular housing 2, adjacent to the second open end 4, allowing the base plate 7 to press directly against the supply tank 1 and cover the entirety of the second open end 4. The second sealant layer 17 is adhered in between the rim 8 and the tubular housing 2, thereby preventing any attractant solution from escaping from the second open end 4 and in between the rim 8 and the tubular housing 2.

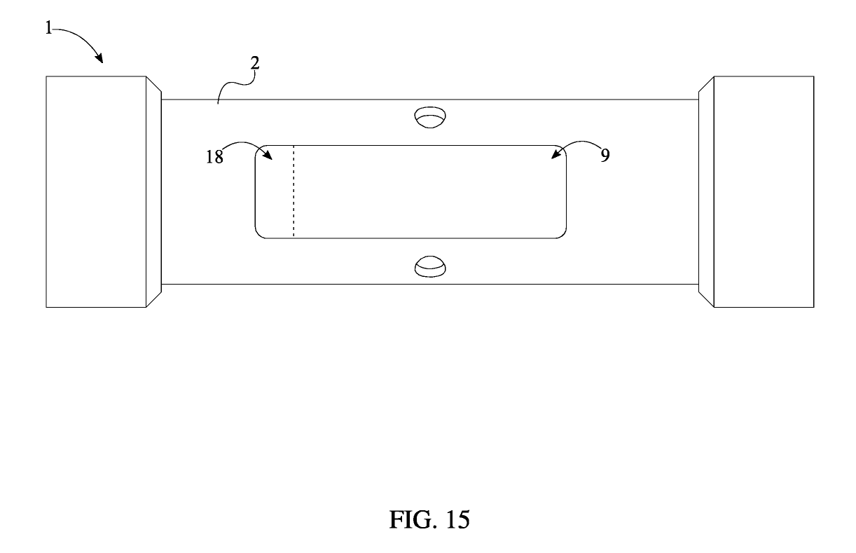

As the supply tank 1 is effectively sealed to maintain a reserve of attractant solution, an alternate embodiment of the present invention comprises at least one fill hole 18, shown in FIG. 15. The at least one fill hole 18 allows the supply tank 1 to be refilled with attractant solution without having to separate the first cap 5, the second cap 6, the axle rod 11, and the wheel 10 from the supply tank 1. The at least one fill hole 18 traverses into the supply tank 1. The at least one fill hole 18 is preferably positioned adjacent the attractant slot 9 in order to prevent any attractant solution from escaping the supply tank 1 through the at least one fill hole 18.

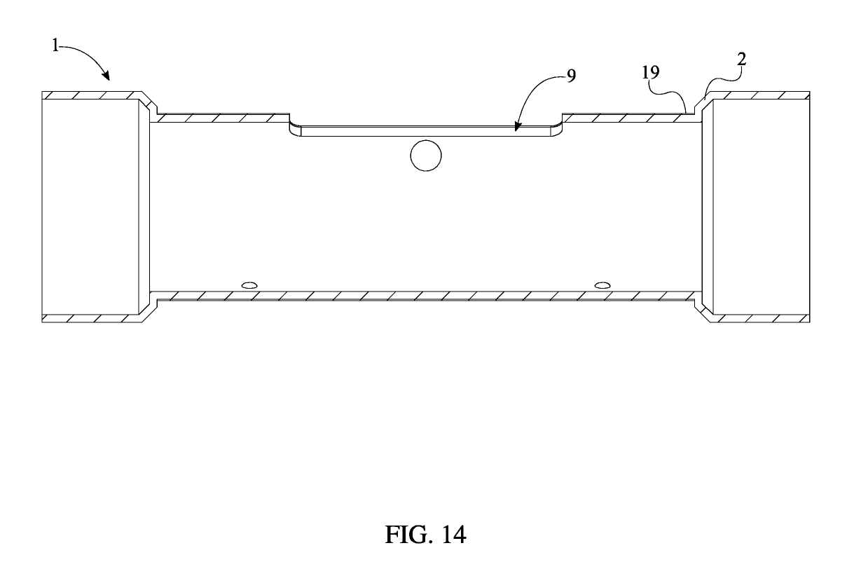

In order to better conceal the present invention and make the present invention more inviting to an animal, an alternate embodiment of the present invention further comprises a camouflage layer 19, shown in FIG. 14. The camouflage layer 19 is externally adhered around the supply tank 1. This arrangement reduces the visual recognition by an animal that the present invention is in fact an attractant dispenser.

Although the invention has been explained in relation to its preferred embodiment, it is to be understood that many other possible modifications and variations can be made without departing from the spirit and scope of the invention as hereinafter claimed.

1. A hunting-attractant dispenser comprising:
a supply tank;
an attractant slot;
a wheel;
an axle rod device;
the attractant slot traversing into the supply tank;
the axle rod device penetrating the supply tank;
the axle rod device being positioned perpendicular and adjacent to the attractant slot;
the axle rod device being centrally aligned along the attractant slot;
the wheel being rotatably connected to the axle rod device;
the wheel being positioned through the attractant slot;
the axle rod device comprising a bolt and two nuts;
the bolt being connected in between the two nuts;
the bolt penetrating the supply tank; and
the supply tank being located in between the two nuts.

2. The hunting-attractant dispenser as claimed in claim 1 comprising:
a first elongated mounting brace;
a second elongated mounting brace;
the first elongated mounting brace and the second elongated mounting brace being connected to the supply tank, opposite the attractant slot;
the first elongated mounting brace being oriented parallel and offset to the second elongated mounting brace; and
the first elongated mounting brace and the second elongated mounting brace being oriented perpendicular to the attractant slot.

3. The hunting-attractant dispenser as claimed in claim 2 comprising:
a first camouflage layer;
a second camouflage layer;
the first camouflage layer wrapping around the first elongated mounting brace; and
the second camouflage layer wrapping around the second elongated mounting brace.

4. The hunting-attractant dispenser as claimed in claim 1 comprising:
the supply tank comprising a tubular housing, a first cap, and a second cap;
the tubular housing comprising a first open end and a second open end;
the attractant slot being laterally positioned along the tubular housing in between the first open end and the second open end;
the first cap being hermetically connected to the first open end; and
the second cap being hermetically connected to the second open end.

5. The hunting-attractant dispenser as claimed in claim 4 comprising:
a first sealant layer;
the first cap comprising a base plate and a rim;
the rim being perimetrically connected to the base plate;
the rim being oriented perpendicular with the base plate;
the base plate being laterally positioned across the first open end;
the rim surrounding the tubular housing, adjacent to the first open end; and
the first sealant layer being adhered positioned in between the rim and the tubular housing.

6. The hunting-attractant dispenser as claimed in claim 4 comprising:
a second sealant layer;
the second cap comprising a base plate and a rim;
the rim being perimetrically connected to the base plate;
the rim being oriented perpendicular with the base plate;
the base plate being laterally positioned across the second open end;
the rim surrounding the tubular housing, adjacent to the second open end; and
the second sealant layer being adhered positioned in between the rim and the tubular housing.

7. The hunting-attractant dispenser as claimed in claim 1 comprising:
at least one fill hole;
the at least one fill hole traversing into the supply tank; and
the at least one fill hole being positioned adjacent the attractant slot.

8. The hunting-attractant dispenser as claimed in claim 1 comprising:
a camouflage layer; and
the camouflage layer wrapping around the supply tank.

9. A hunting-attractant dispenser comprising:
a supply tank;
an attractant slot;
a wheel;
an axle rod device;
a first elongated mounting brace;
a second elongated mounting brace;
the attractant slot traversing into the supply tank;
the axle rod device penetrating the supply tank;
the axle rod device being positioned perpendicular and adjacent to the attractant slot;
the axle rod device being centrally aligned along the attractant slot;
the wheel being rotatably connected to the axle rod device;
the wheel being positioned through the attractant slot;
the first elongated mounting brace and the second elongated mounting brace being connected to the supply tank, opposite the attractant slot;
the first elongated mounting brace being oriented parallel and offset to the second elongated mounting brace;
the first elongated mounting brace and the second elongated mounting brace being oriented perpendicular to the attractant slot:,
the axle rod device comprising a bolt and two nuts;
the bolt being connected in between the two nuts;
the bolt penetrating the supply tank; and
the supply tank being located in between the two nuts.

10. The hunting-attractant dispenser as claimed in claim 9 comprising:
a first camouflage layer;
a second camouflage layer;
the first camouflage layer wrapping around the first elongated mounting brace; and
the second camouflage layer wrapping around the second elongated mounting brace.

11. The hunting-attractant dispenser as claimed in claim 9 comprising:
the supply tank comprising a tubular housing, a first cap, and a second cap;
the tubular housing comprising a first open end and a second open end;
the attractant slot being laterally positioned along the tubular housing in between the first open end and the second open end;
the first cap being hermetically connected to the first open end; and
the second cap being hermetically connected to the second open end.

12. The hunting-attractant dispenser as claimed in claim 11 comprising:
a first sealant layer;
the first cap comprising a base plate and a rim;
the rim being perimetrically connected to the base plate;
the rim being oriented perpendicular with the base plate;
the base plate being laterally positioned across the first open end;
the rim surrounding the tubular housing, adjacent to the first open end; and
the first sealant layer being adhered positioned in between the rim and the tubular housing.

13. The hunting-attractant dispenser as claimed in claim 11 comprising:
a second sealant layer;
the second cap comprising a base plate and a rim;
the rim being perimetrically connected to the base plate;
the rim being oriented perpendicular with the base plate;
the base plate being laterally positioned across the second open end;
the rim surrounding the tubular housing, adjacent to the second open end; and
the second sealant layer being adhered positioned in between the rim and the tubular housing.

14. The hunting-attractant dispenser as claimed in claim 9 comprising:
at least one fill hole;
the at least one fill hole traversing into the supply tank; and the at least one fill hole being positioned adjacent the attractant slot.

15. The hunting-attractant dispenser as claimed in claim 9 comprising:
a camouflage layer; and
the camouflage layer wrapping around the supply tank.
